(19) United States
(12) Patent Application Publication
(10) Pub. No.: US 2025/0175870 A1
(43) Pub. Date: May 29, 2025

(54) FIFTH GENERATION (5G) NETWORK HAVING SMALL CELLS CONTROLLED BY A SINGLE CONTROL UNIT

(71) Applicant: DISH Wireless L.L.C., Englewood, CO (US)

(72) Inventors: Mehdi Alasti, Arlington, VA (US); Khalid Al-Mufti, Sterling, VA (US); Siddhartha Chenumolu, Ashburn, VA (US)

(21) Appl. No.: 18/520,108

(22) Filed: Nov. 27, 2023

(51) Int. Cl. H04W 36/04; H04L 5/00; H04W 36/22; H04W 36/30

(52) U.S. Cl. CPC H04W 36/04; H04L 5/0032; H04W 36/22; H04W 36/304

(57) ABSTRACT

A cellular communication system includes a plurality of small cell radio access points (APs), a cloud server communicatively coupled to each of the small cell radio APs, and a 5G core communicatively coupled to the cloud server. Each small cell radio AP includes a Radio Unit (RU) and a Distributed Unit (DU), wherein a DU of an AP at least partially controls operation of the respective RU of the AP. The cloud server implements a control unit (CU) that at least partially controls operation of the plurality of small cell radio APs. The CU further provides each small cell radio AP access to the 5G core.

### TECHNICAL FIELD

The present disclosure relates generally to wireless communications, and more specifically to a 5^{th} Generation (5G) network having small cells controlled by a single control unit (CU).

### BACKGROUND

A Fifth Generation (5G) base station or gNB is mainly split into three parts namely Radio Unit (RU), Distributed Unit (DU) and Control Unit (CU). RU is the radio hardware entity that converts radio signals sent to and from the antenna into digital signal for transmission over a packet network. The RU handles the digital front end (DFE) and the lower physical (PHY) layer. DU is a software entity that is deployed on site on a server. DU software is normally deployed close to the RU on site and provides support for the lower layers of the protocol stack such as the radio link control (RLC), medium access control (MAC), and parts of the PHY layer. The CU provides support for the higher layers of the protocol stack such as the service data adaptation protocol (SDAP), packet data convergence protocol (PDCP) and radio resource control (RRC).

### SUMMARY

Embodiments of the present disclosure describe an improved network architecture for a small cell network. As described in accordance with embodiments of the present disclosure, an improved cellular communication system includes a plurality of small cell radio access points (APs), wherein each small cell radio AP includes a Radio Unit (RU) and a Distributed Unit DU only. A common control unit (CU) that is implemented by a cloud server controls all the small cell radio APs. Thus, each small cell radio AP implements the PHY, RLC and MAC layers only of the 5G RAN protocol stack. The higher layers such as the SDAP, PDCP and RRC layers are implemented by the CU which is common to all small cell radio APs. In addition, the cellular communication system may include a macro base station which is also controlled by the common CU. In other words, all the small cell radio APs, the macro base station and the common CU together form a single gNB. The improved architecture of the disclosed cellular communication system helps provide several practical applications and technical advantages. For example, the disclosed cellular communication system allows the CU to implement and control several intra-gNB operations in the cellular communication system between small cell radio APs or a small cell radio AP and the macro base station. For example, the CU may control an intra-gNB handover of a User Equipment (UE) between two small cell radio APs or between a small cell radio AP and the macro base station. In another example, the CU may perform intra-gNB inter-cell interference coordination (ICIC) between two or more small cell radio APs with overlapping cell coverage or between a small cell radio access point and the macro base station with overlapping cell coverage. In another example, the CU may implement and control intra-gNB dual connectivity of a UE to two small cell radio APs or to a small cell radio AP and the macro base station. By allowing the UE to simultaneously communicate with two different small cell radio APs, the CU increases data throughput of the UE. In another example, the CU may implement and control intra-gNB load balancing between two or more small cell radio APs or between one or more small cell radio APs and the macro base station.

In contrast, a traditional small cell network in which each small cell radio AP includes its own RU, DU and CU. In other words, each traditional small cell radio AP is a separate gNB that includes all the three components of the 5G NR RAN architecture to implement the entire 5G RAN protocol stack. Thus, each of the operations noted above in a traditional small cell network are inter-gNB operations controlled at the 5G core level. The intra-gNB operations controlled by the common CU are more efficient and use lesser network and computing resources as compared to an inter-gNB operations in traditional systems. Thus, the disclosed system and method improve network efficiency and overall operation of the cellular communication system. Accordingly, the disclosed system and method generally improve cellular communication technology.

### BRIEF DESCRIPTION OF THE DRAWINGS

For a more complete understanding of this disclosure, reference is now made to the following brief description, taken in connection with the accompanying drawings and detailed description, wherein like reference numerals represent like parts.

FIG. 1 illustrates an example of a communication system, in accordance with embodiments of the present disclosure;

FIG. 2 is a flowchart of an example method for a method for wireless communication, in accordance with embodiments of the present disclosure; and

FIG. 3 illustrates an example schematic diagram of the Control Unit (CU) illustrated in FIG. 1, in accordance with one or more embodiments of the present disclosure.

### DETAILED DESCRIPTION

### System Overview

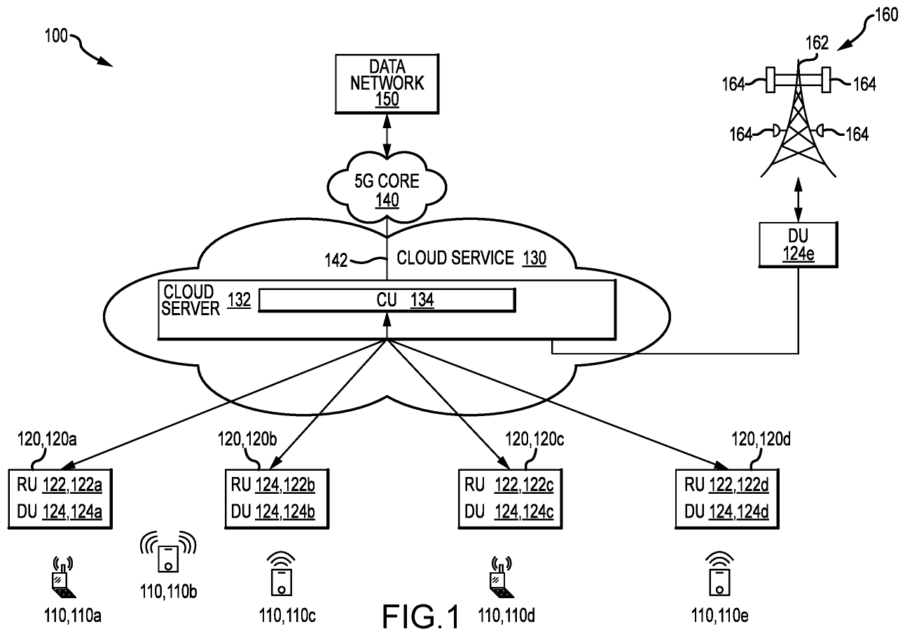

FIG. 1 illustrates an example of a communication system 100, in accordance with embodiments of the present disclosure. As shown in FIG. 1, communication system 100 may include a plurality of small cell radio access points (APs) 120 (shown as including APs 120a, 120b, 120c and 120d), a macro base station 160, a plurality of user equipment (UEs) 110 (shown as UEs 110a, 110b, 110c, 110d, and 110e), a cloud service 130, a 5G Core 140, and a data network 150. Each small cell radio AP 120 may be associated with a femto cell, a pico cell or a micro cell. Generally, small cells are low-cost and low-powered radio access points or base stations that complement the primary cellular network of a mobile operator by providing targeted indoor and outdoor coverage to customers in smaller locations like homes, offices, shopping malls, train stations etc. Small cells may be deployed indoors or outdoors and in licensed, shared or unlicensed spectrum. Small cells deliver high-quality, secure cellular coverage indoors and outdoors, complementing the macro network (e.g., associated with macro base station 160) to improve coverage, add targeted capacity, and support new services. There are various types of small cells, with varying ranges, power levels and form factors, according to the use case. Examples of small cells include femtocells, picocells and microcells that complement the primary cellular coverage provided by the macro cells (e.g., macro base station 160) within a cellular network. Among all small cells, femtocells have the shortest range, a radius of up to 10 meters. Picocells have a slightly longer range and cover a radius of up to 200 meters, whereas microcells can cover a radius of up to 2 kilometers. The regular cells in mobile networks are called macro cells (e.g., macro base station 160) that cover tens of kilometers.

In accordance with 5G RAN architecture, a gNB typically includes three components that implement the entire 5G RAN protocol stack. A Radio Unit (RU) associated with a gNB generally refers to a radio hardware entity that converts radio signals sent to and from the antenna into digital signals for transmission over a packet network. The RU handles the digital front end (DFE) and the lower physical (PHY) layer. A distributed unit (DU) associated with the gNB is generally a software entity that is deployed at a cell site (e.g., including one or more RUs) on a server and provides support for the lower layers of the protocol stack such as the radio link control (RLC), medium access control (MAC), and parts of the PHY layer. A Control Unit (CU) associated with the gNB may also be a software entity that is deployed on a server and provides support for the higher layers of the protocol stack such as the service data adaptation protocol (SDAP), packet data convergence protocol (PDCP) and radio resource control (RRC). The CU of a gNB connects to a 5G core (e.g., 5G core 140) which provides access to a data network (e.g., data network 150). Each gNB may include one CU, but one CU may control multiple DUs. Further, each DU may support a plurality of cell sites. In one embodiment, a cell site may include 6 RUs controlled by one DU.

Presently, each small cell radio AP includes its own RU, DU and CU. In other words, each traditional small cell radio AP is a separate gNB that includes all the three components of the 5G NR RAN architecture to implement the entire 5G RAN protocol stack.

Embodiments of the present disclosure describe an improved network architecture for a small cell network. For example, as shown in FIG. 1, each small cell radio AP 120 includes an RU 122 and a DU 124 only. As shown, AP 120a includes RU 122a and DU 124a, AP 120b includes RU 122b and DU 124b, AP 120c includes RU 122c and DU 124c, and AP 120d includes RU 122d and DU 124d. Each RU 122 represents a radio hardware entity associated with the respective small cell radio AP 120 that allows the AP 120 to wirelessly communicate with UEs 110. Unlike a traditional small cell radio AP, the small cell radio APs 120 shown in FIG. 1 do not include a CU. Instead, a common CU 134 is implemented by a cloud server 132 provided by the cloud service 130. The cloud server 132 is communicatively coupled to each small cell radio AP 120 via a wired or wireless connection. The CU 134 is configured to control each DU 124 (e.g., DUs 124a, 124b, 124c, and 124d) of each small cell radio AP 120 (e.g., APs 120a, 120b, 120c, and 120d respectively). Thus, unlike a traditional small cell radio AP, each small cell radio AP 120 implements the PHY, RLC and MAC layers only of the 5G RAN protocol stack. The higher layers such as the SDAP, PDCP and RRC layers are implemented by the CU 134 which is common to all small cell radio APs 120. In other words, all the small cell radio APs and the common CU 134 together form a single gNB.

As shown in FIG. 1, the macro base station 160 includes a base station tower 162 having one or more radio antennas 164 mounted thereon. The antennas 164 deployed on the base station tower 162 may be part of the RU associated with the macro base station 160. The macro base station 160 further includes a DU 124e that is communicatively coupled to the base station tower 162 and controls operation of the base station tower 162. In certain embodiments, the DU 124e may be communicatively coupled to the cloud server 132 such that the CU 134 controls the DU 124e associated with the macro base station 160 in addition to controlling the DUs 124a, 124b, 124c and 124d associated with the small cell radio APs 120a, 120b, 120c and 120d respectively. Thus, in this context, the macro base station 160 is also part of the same gNB that includes the small cell radio APs 120 and the CU 134.

The cloud server 132 connects the CU 134 to the 5G core 140 which provides access to the data network 150. The 5G Core 140 is the heart of a 5G mobile network. It establishes reliable, secure connectivity to the network for end users and provides access to its services. The 5G core 140 handles a wide variety of essential functions in the mobile network, such as connectivity and mobility management, authentication and authorization, subscriber data management and policy management, among others. 5G Core network functions are completely software-based and designed as cloud-native, allowing higher deployment agility and flexibility on multiple cloud infrastructures.

Each UE 110 is configured to wirelessly communicate with one AP 120 at any time or simultaneously communicate with multiple APs 120.

The data network 150, in general, may be a wide area network (WAN), a personal area network (PAN), a cellular network, or any other technology that allows devices to communicate electronically with other devices. In one or more embodiments, the data network 150 may be the Internet. Each UE 110 may be operated by one or more users. Each UE 110 may be a computing device (e.g., desktop computer, laptop computer, tablet computer, smart phone etc.) that can be operated by a user and communicate with other devices such as the small cell radio APs 120 and/or the macro base station 160.

In one or more embodiments, each of the RUs 122, DUs 124, CU 134/cloud server 132 and UEs 110 may be implemented by a computing device running one or more software applications. For example, one or more of the RUs 122, DUs 124, CU 134/cloud server 132 and UEs 110 may be representative of a computing system hosting software applications that may be installed and run locally or may be used to access software applications running on a server (not shown). The computing system may include mobile computing systems including smart phones, tablet computers, laptop computers, or any other mobile computing devices or systems capable of running software applications and communicating with other devices. The computing system may also include non-mobile computing devices such as desktop computers or other non-mobile computing devices capable of running software applications and communicating with other devices. In certain embodiments, one or more of the RUs 122, DUs 124, CU 134/cloud server 132 and UEs 110 may be representative of a server running one or more software applications to implement respective functionality as described below. In certain embodiments, one or more of the RUs 122, DUs 124, CU 134/cloud server 132 and UEs 110 may run a thin client software application where the processing is directed by the thin client but largely performed by a central entity such as a server (not shown).

In one or more embodiments, the CU 134 may be configured to implement and control several intra-gNB operations in the communication system 100. As noted above, the small cell radio APs 120 and the macro base station 160 are controlled by the same the CU 134, and thus, are part of a single gNB.

In one embodiment, the CU 134 may implement and control an intra-gNB handover of a UE 110 between two small cell radio APs 120. For example, a UE 110b that is connected to the AP 120a may be configured to measure signal quality (e.g., reference signal received power (RSRP), reference signal received quality (RSRQ), signal-to-noise and interference ratio (SNIR) etc.) of radio signals received from the AP 120a to which the UE 110b is connected to and also measure signal quality of radio signals received from other neighboring APs (e.g., AP 120b) that the UE 110b detects. For example, when the UE 110b is near the cell edge associated with AP 120a, the UE 110 may be within an overlapping cell coverage region associated with APs 120a and 120b. In this case, the UE 110b may receive radio signals from both neighboring APs 120a and 120b. The UE 110b may be configured to periodically transmit measurement reports to the AP 120a to which the UE 110b is connected, wherein the measurement reports include signal quality measurements (e.g., RSRP, RSRQ, SINR etc.) associated with the AP 120a as well as the AP 120b. The AP 120a may forward the measurement reports received from the UE 110b to the CU 134. Based on the measurement reports reported by the UE 110b, the CU 134 may be configured to determine whether the UE 110b is to be handed over from the AP 120a to the AP 120b. For example, when the measured signal quality of the radio signal as measured by the UE 110b equals or exceeds a threshold, the CU 134 determines that the UE 110b is to be handed over to the AP 120b. In response to making this determination, the CU 134 initiates a handover procedure that handovers the UE 110b from the AP 120a to the AP 120b. It may be noted that in traditional small cell networks, since each small cell is a separate gNB, a handover of a UE 110 between two small cells is generally an inter-gNB handover which is controlled and implemented at the 5G core (e.g., 5G core 140). In contrast, the example handover of the UE 110b from the AP 120a to 120b as described above is an intra-gNB handover controlled by the CU 134. The intra-gNB handover is more efficient and uses lesser network and computing resources as compared to an inter-gNB handover.

In an additional or alternative embodiment, the CU 134 may perform a similar process to handover a UE 110 between a small cell radio AP 120 and the macro base station 160. Since the CU 134 controls the macro base station 160 and the small cell radio access points 120, a handover of a UE 110 between a small cell radio AP 120 and the macro base station 160 will also be an intra-gNB handover. For example, the UE 110e that is actively connected to the small cell radio AP 120d but is moving into the cell coverage of the macro base station 160 may periodically transmit measurement reports to the AP 120d including signal quality measurements relating to the radio signals associated with the AP 120d as well as the macro base station 160. The AP 120d may forward the measurement reports to the CU 134, which may determine whether the UE 110e is to be handed over to the macro base station 160 based on the measurement reports received from the UE 110e. For example, when the measured signal quality associated with the macro base station 160 as measured by the UE 110e equals or exceeds a threshold, the CU 134 determines that the UE 110e is to be handed over to the macro base station 160. In response to making this determination, the CU 134 initiates a handover procedure that handovers the UE 110e from the AP 120d to the macro base station 160. It may be noted that a similar process may be used by the CU 134 to handover a UE 110 (e.g., UE 110e) from the macro base station 160 to a small cell radio AP 120.

In an additional or alternative embodiment, the CU 134 may perform inter-cell interference coordination (ICIC) between two or more small cell radio access points 120 with overlapping cell coverage or between a small cell radio access point 120 and the macro base station 160 with overlapping cell coverage. Generally, when a UE 110 is at cell edges associated with overlapping cell coverages of two cells (e.g., two small cells or a small cell and macro cell), and both overlapping cells use the same communication frequencies, the radio signals in both cells may interfere with each other. ICIC reduces inter-cell interference by having UEs 110, at the same cell edge but belonging to different cells, use different frequency resources. In this context, CU 134 may coordinate between two or more small cells radio APs 120 so that UEs 110 operating in a region of overlapping cell coverage associated with two neighboring APs 120 are assigned different non-interfering frequency resources to communicate with the two neighboring APs 120. For example, assuming that UE 110b connected to AP 120a and UE 110c connected to AP 120 are operating in a region of overlapping cell coverage associated with APs 120a and 120b, the CU 134 assigns a first frequency (or a first set of frequencies) for communications between the UE 110b and AP 120a and a different second frequency (or second set of frequencies) for communications between the UE 110c and the AP 120b. This avoids each of the UEs 110b and 110c from interfering with transmissions occurring in the neighboring cell. It may be noted that the CU 134 may use a similar process to implement ICIC between a small cell radio AP 120 and the macro base station 160.

In an additional or alternative embodiment, CU 134 may implement and control dual connectivity of a UE 110 to two small cell radio APs 120 or to a small cell radio AP 120 and the macro base station 160. Since all the small cell radio APs 120 and the macro base station 160 are controlled by a common CU 134, the dual connectivity implemented by the CU 134 are intra-gNB procedures. For example, when the UE 110b is operating in a region of overlapping cell coverage associated with APs 120a and 120b, the CU 134 may assign multiple transmit-receive pairs (TRPs) to the UE 110b to simultaneously communicate with both APs 120a and 120b. For example, the CU 134 may assign a first carrier frequency for communications between the UE 110b and AP 120a and may assign a different second carrier frequency for communications between the UE 110b and the AP 120b. By allowing the UE 110b to simultaneously communicate with two different small cell radio APs 120a and 120b, the CU 134 increases data throughput of the UE 110b. It may be noted that the CU 134 may use a similar process to implement and control dual connectivity of a UE 110 to a small cell radio AP 120 and the macro base station 160.

In an additional or alternative embodiment, CU 134 may implement and control load balancing between two or more small cell radio APs 120 or between one or more small cell radio APs 120 and the macro base station 160. Since all the small cell radio APs 120 and the macro base station 160 are controlled by a common CU 134, the load balancing implemented by the CU 134 are intra-gNB procedures. For example, when the UE 110b is operating in a region of overlapping cell coverage associated with APs 120a and 120b, and the CU 134 determines that the AP 120a to which the UE 110b is connected to is overloaded and that the AP 120b can handle more load, the CU 134 may handover the UE 110b to the AP 120b to reduce the load at AP 120a.

In one or more embodiments, the CU 134 may implement and control other intra-gNB procedures including, but not limited to, 5G positioning of a UE 110 by trilateration using small cell radio APs 120.

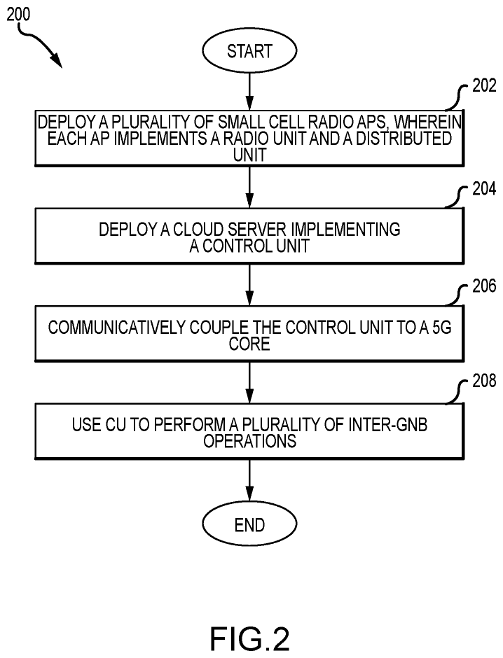

FIG. 2 is a flowchart of an example method 200 for a method for wireless communication, in accordance with embodiments of the present disclosure.

At operation 202, a plurality of small cell radio access points (APs) 120 are deployed. Each small cell radio AP 120 is associated with a small cell including a femto cell, a pico cell or a micro cell. Each small cell radio AP includes a RU 122 and a DU 124 communicatively coupled to the RU 122, wherein the RU 122 comprises radio hardware used to communicate with UEs 110 and supports at least a PHY layer of a communication protocol stack associated with a 5G cellular network. Each DU 124 is a software entity deployed by a computing node at the respective small cell radio AP 120 and supports at least an RLC layer and a MAC layer of the 5G communication protocol stack. The DU 124 at least partially controls operation of the RU 122.

At operation 204, a cloud server 132 is deployed, wherein the cloud server 132 is communicatively coupled to each of the plurality of small cell radio APs. The cloud server 132 implements a CU 134 that at least supports an SDAP layer, a PDCP layer and a RRC layer of the 5G communication protocol stack. The CU 134 at least partially controls operation of a plurality of DU 124 associated with the plurality of small cell radio APs 120.

At operation 206, the CU 134 is communicatively coupled to a 5G core 140, wherein the CU 134 provides each small cell radio APs 120 access to the 5G core.

As shown in FIG. 1, communication system 100 may include a plurality of small cell radio APs 120 (shown as including APs 120a, 120b, 120c and 120d), a macro base station 160, a plurality of user equipment (UEs) 110 (shown as UEs 110a, 110b, 110c, 110d, and 110e), a cloud service 130, a 5G Core 140, and a data network 150. Each small cell radio AP 120 may be associated with a femto cell, a pico cell or a micro cell.

Each small cell radio AP 120 includes an RU 122 and a DU 124 only. As shown, AP 120a includes RU 122a and DU 124a, AP 120b includes RU 122b and DU 124b, AP 120c includes RU 122c and DU 124c, and AP 120d includes RU 122d and DU 124d. Each RU 122 represents a radio hardware entity associated with the respective small cell radio AP 120 that allows the AP 120 to wirelessly communicate with UEs 110. Unlike a traditional small cell radio AP, the small cell radio APs 120 shown in FIG. 1 do not include a CU. Instead, a common CU 134 is implemented by a cloud server 132 provided by the cloud service 130. The cloud server 132 is communicatively coupled to each small cell radio AP 120 via a wired or wireless connection. The CU 134 is configured to control each DU 124 (e.g., DUs 124a, 124b, 124c, and 124d) of each small cell radio AP 120 (e.g., APs 120a, 120b, 120c, and 120d respectively). Thus, unlike a traditional small cell radio AP, each small cell radio AP 120 implements the PHY, RLC and MAC layers only of the 5G RAN protocol stack. The higher layers such as the SDAP, PDCP and RRC layers are implemented by the CU 134 which is common to all small cell radio APs 120. In other words, all the small cell radio APs and the common CU 134 together form a single gNB.

As shown in FIG. 1, the macro base station 160 includes a base station tower 162 having one or more radio antennas 164 mounted thereon. The antennas 164 deployed on the base station tower 162 may be part of the RU associated with the macro base station 160. The macro base station 160 further includes a DU 124e that is communicatively coupled to the base station tower 162 and controls operation of the base station tower 162. In certain embodiments, the DU 124e may be communicatively coupled to the cloud server 132 such that the CU 134 controls the DU 124e associated with the macro base station 160 in addition to controlling the DUs 124a, 124b, 124c and 124d associated with the small cell radio APs 120a, 120b, 120c and 120d respectively. Thus, in this context, the macro base station 160 is also part of the same gNB that includes the small cell radio APs 120 and the CU 134.

The cloud server 132 connects the CU 134 to the 5G core 140 which provides access to the data network 150. The 5G Core 140 is the heart of a 5G mobile network. It establishes reliable, secure connectivity to the network for end users and provides access to its services. The 5G core 140 handles a wide variety of essential functions in the mobile network, such as connectivity and mobility management, authentication and authorization, subscriber data management and policy management, among others. 5G Core network functions are completely software-based and designed as cloud-native, allowing higher deployment agility and flexibility on multiple cloud infrastructures. Each UE 110 is configured to wirelessly communicate with one AP 120 at any time or simultaneously communicate with multiple APs 120.

At operation 208, the CU 134 is used to perform a plurality of intra-gNB operations.

As described above, the CU 134 may be configured to implement and control several intra-gNB operations in the communication system 100. As noted above, the small cell radio APs 120 and the macro base station 160 are controlled by the same the CU 134, and thus, are part of a single gNB.

In one embodiment, the CU 134 may implement and control an intra-gNB handover of a UE 110 between two small cell radio APs 120. For example, a UE 110b that is connected to the AP 120a may be configured to measure signal quality (e.g., reference signal received power (RSRP), reference signal received quality (RSRQ), signal-to-noise and interference ratio (SNIR) etc.) of radio signals received from the AP 120a to which the UE 110b is connected to and also measure signal quality of radio signals received from other neighboring APs (e.g., AP 120b) that the UE 110b detects. For example, when the UE 110b is near the cell edge associated with AP 120a, the UE 110 may be within an overlapping cell coverage region associated with APs 120a and 120b. In this case, the UE 110b may receive radio signals from both neighboring APs 120a and 120b. The UE 110b may be configured to periodically transmit measurement reports to the AP 120a to which the UE 110b is connected, wherein the measurement reports include signal quality measurements (e.g., RSRP, RSRQ, SINR etc.) associated with the AP 120a as well as the AP 120b. The AP 120a may forward the measurement reports received from the UE 110b to the CU 134. Based on the measurement reports reported by the UE 110b, the CU 134 may be configured to determine whether the UE 110b is to be handed over from the AP 120a to the AP 120b. For example, when the measured signal quality of the radio signal as measured by the UE 110b equals or exceeds a threshold, the CU 134 determines that the UE 110b is to be handed over to the AP 120b. In response to making this determination, the CU 134 initiates a handover procedure that handovers the UE 110b from the AP 120a to the AP 120b. It may be noted that in traditional small cell networks, since each small cell is a separate gNB, a handover of a UE 110 between two small cells is generally an inter-gNB handover which is controlled and implemented at the 5G core (e.g., 5G core 140). In contrast, the example handover of the UE 110b from the AP 120a to 120b as described above is an intra-gNB handover controlled by the CU 134. The intra-gNB handover is more efficient and uses lesser network and computing resources as compared to an inter-gNB handover.

In an additional or alternative embodiment, the CU 134 may perform a similar process to handover a UE 110 between a small cell radio AP 120 and the macro base station 160. Since the CU 134 controls the macro base station 160 and the small cell radio access points 120, a handover of a UE 110 between a small cell radio AP 120 and the macro base station 160 will also be an intra-gNB handover. For example, the UE 110e that is actively connected to the small cell radio AP 120d but is moving into the cell coverage of the macro base station 160 may periodically transmit measurement reports to the AP 120d including signal quality measurements relating to the radio signals associated with the AP 120d as well as the macro base station 160. The AP 120d may forward the measurement reports to the CU 134, which may determine whether the UE 110e is to be handed over to the macro base station 160 based on the measurement reports received from the UE 110e. For example, when the measured signal quality associated with the macro base station 160 as measured by the UE 110e equals or exceeds a threshold, the CU 134 determines that the UE 110e is to be handed over to the macro base station 160. In response to making this determination, the CU 134 initiates a handover procedure that handovers the UE 110e from the AP 120d to the macro base station 160. It may be noted that a similar process may be used by the CU 134 to handover a UE 110 (e.g., UE 110e) from the macro base station 160 to a small cell radio AP 120.

In an additional or alternative embodiment, the CU 134 may perform inter-cell interference coordination (ICIC) between two or more small cell radio access points 120 with overlapping cell coverage or between a small cell radio access point 120 and the macro base station 160 with overlapping cell coverage. Generally, when a UE 110 is at cell edges associated with overlapping cell coverages of two cells (e.g., two small cells or a small cell and macro cell), and both overlapping cells use the same communication frequencies, the radio signals in both cells may interfere with each other. ICIC reduces inter-cell interference by having UEs 110, at the same cell edge but belonging to different cells, use different frequency resources. In this context, CU 134 may coordinate between two or more small cells radio APs 120 so that UEs 110 operating in a region of overlapping cell coverage associated with two neighboring APs 120 are assigned different non-interfering frequency resources to communicate with the two neighboring APs 120. For example, assuming that UE 110b connected to AP 120a and UE 110c connected to AP 120 are operating in a region of overlapping cell coverage associated with APs 120a and 120b, the CU 134 assigns a first frequency (or a first set of frequencies) for communications between the UE 110b and AP 120a and a different second frequency (or second set of frequencies) for communications between the UE 110c and the AP 120b. This avoids each of the UEs 110b and 110c from interfering with transmissions occurring in the neighboring cell. It may be noted that the CU 134 may use a similar process to implement ICIC between a small cell radio AP 120 and the macro base station 160.

In an additional or alternative embodiment, CU 134 may implement and control dual connectivity of a UE 110 to two small cell radio APs 120 or to a small cell radio AP 120 and the macro base station 160. Since all the small cell radio APs 120 and the macro base station 160 are controlled by a common CU 134, the dual connectivity implemented by the CU 134 are intra-gNB procedures. For example, when the UE 110b is operating in a region of overlapping cell coverage associated with APs 120a and 120b, the CU 134 may assign multiple transmit-receive pairs (TRPs) to the UE 110b to simultaneously communicate with both APs 120a and 120b. For example, the CU 134 may assign a first carrier frequency for communications between the UE 110b and AP 120a and may assign a different second carrier frequency for communications between the UE 110b and the AP 120b. By allowing the UE 110b to simultaneously communicate with two different small cell radio APs 120a and 120b, the BU 134 increases data throughput of the UE 110b. It may be noted that the CU 134 may use a similar process to implement and control dual connectivity of a UE 110 to a small cell radio AP 120 and the macro base station 160.

In an additional or alternative embodiment, CU 134 may implement and control load balancing between two or more small cell radio APs 120 or between one or more small cell radio APs 120 and the macro base station 160. Since all the small cell radio APs 120 and the macro base station 160 are controlled by a common CU 134, the load balancing implemented by the CU 134 are intra-gNB procedures. For example, when the UE 110b is operating in a region of overlapping cell coverage associated with APs 120a and 120b, and the CU 134 determines that the AP 120a to which the UE 110b is connected to is overloaded and that the AP 120b can handle more load, the CU 134 may handover the UE 110b to the AP 120b to reduce the load at AP 120a.

In one or more embodiments, the CU 134 may implement and control other intra-gNB procedures including, but not limited to, 5G positioning of a UE 110 by trilateration using small cell radio APs 120.

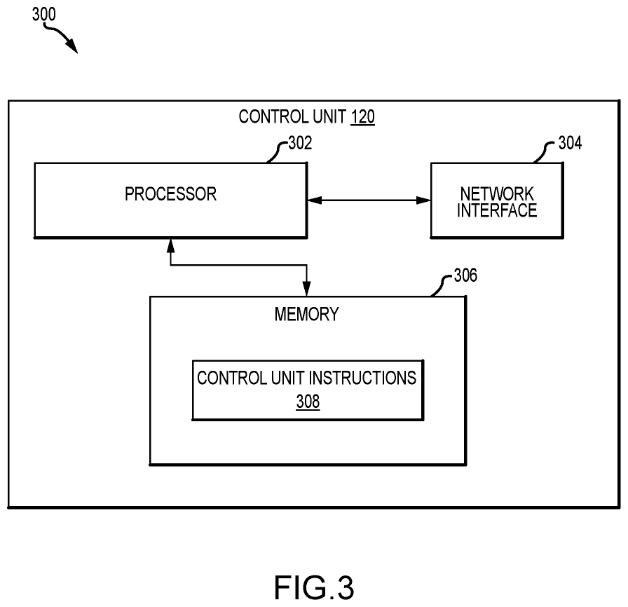

FIG. 3 illustrates an example schematic diagram of the Control Unit (CU) 134 illustrated in FIG. 1, in accordance with one or more embodiments of the present disclosure.

CU 134 includes a processor 302, a memory 306, and a network interface 304. The CU 134 may be configured as shown in FIG. 3 or in any other suitable configuration.

The processor 302 comprises one or more processors operably coupled to the memory 306. The processor 302 is any electronic circuitry including, but not limited to, state machines, one or more central processing unit (CPU) chips, logic units, cores (e.g., a multi-core processor), field-programmable gate array (FPGAs), application specific integrated circuits (ASICs), or digital signal processors (DSPs). The processor 302 may be a programmable logic device, a microcontroller, a microprocessor, or any suitable combination of the preceding. The processor 302 is communicatively coupled to and in signal communication with the memory 306. The one or more processors are configured to process data and may be implemented in hardware or software. For example, the processor 302 may be 8-bit, 16-bit, 32-bit, 64-bit or of any other suitable architecture. The processor 302 may include an arithmetic logic unit (ALU) for performing arithmetic and logic operations, processor registers that supply operands to the ALU and store the results of ALU operations, and a control unit that fetches instructions from memory and executes them by directing the coordinated operations of the ALU, registers and other components.

The one or more processors are configured to implement various instructions. For example, the one or more processors are configured to execute instructions (e.g., control unit instructions 308) to implement the CU 134. In this way, processor 302 may be a special-purpose computer designed to implement the functions disclosed herein. In one or more embodiments, the CU 134 is implemented using logic units, FPGAs, ASICs, DSPs, or any other suitable hardware. The CU 134 is configured to operate as described with reference to FIGS. 1-2. For example, the processor 302 may be configured to perform at least a portion of the method 200 as described in FIG. 2.

The memory 306 comprises one or more disks, tape drives, or solid-state drives, and may be used as an over-flow data storage device, to store programs when such programs are selected for execution, and to store instructions and data that are read during program execution. The memory 306 may be volatile or non-volatile and may comprise a read-only memory (ROM), random-access memory (RAM), ternary content-addressable memory (TCAM), dynamic random-access memory (DRAM), and static random-access memory (SRAM).

The memory 306 is operable to store control unit instructions 308 any other data needed to perform operations disclosed herein. The control unit instructions 308 may include any suitable set of instructions, logic, rules, or code operable to execute the control unit 134.

The network interface 304 is configured to enable wired and/or wireless communications. The network interface 304 is configured to communicate data between the CU 134 and other devices, systems, or domains (e.g. small cell radio APs 120, macro base station 160, 5G core 140 etc.). For example, the network interface 304 may comprise a Wi-Fi interface, a LAN interface, a WAN interface, a modem, a switch, or a router. The processor 302 is configured to send and receive data using the network interface 304. The network interface 304 may be configured to use any suitable type of communication protocol as would be appreciated by one of ordinary skill in the art.

It may be noted that each of the small cell radio APs, the macro base station 160 and the UEs 110, may be implemented similar to the CU 134. For example, each of the small cell radio APs, the macro base station 160 and the UEs 110 may include a processor and a memory storing instructions to implement the respective functionality when executed by the processor.

While several embodiments have been provided in the present disclosure, it should be understood that the disclosed systems and methods might be embodied in many other specific forms without departing from the spirit or scope of the present disclosure. The present examples are to be considered as illustrative and not restrictive, and the intention is not to be limited to the details given herein. For example, the various elements or components may be combined or integrated in another system or certain features may be omitted, or not implemented.

In addition, techniques, systems, subsystems, and methods described and illustrated in the various embodiments as discrete or separate may be combined or integrated with other systems, modules, techniques, or methods without departing from the scope of the present disclosure. Other items shown or discussed as coupled or directly coupled or communicating with each other may be indirectly coupled or communicating through some interface, device, or intermediate component whether electrically, mechanically, or otherwise. Other examples of changes, substitutions, and alterations are ascertainable by one skilled in the art and could be made without departing from the spirit and scope disclosed herein.

To aid the Patent Office, and any readers of any patent issued on this application in interpreting the claims appended hereto, applicants note that they do not intend any of the appended claims to invoke 35 U.S.C. § 112(f) as it exists on the date of filing hereof unless the words “means for” or “step for” are explicitly used in the particular claim.

1. A cellular communication system comprising:
a plurality of small cell radio access points, wherein:
each small cell radio access point is associated with a small cell comprising a femto cell, a pico cell or a micro cell;
each small cell radio access point comprises a Radio Unit (RU) and a Distributed Unit (DU) communicatively coupled to the RU;
the RU comprises radio hardware used to communicate with user equipment (UEs) and supports at least a physical (PHY) layer of a communication protocol stack associated with a cellular network;
the DU is a software entity deployed by a computing node at the radio access point and supports at least a radio link control (RLC) layer and a medium access control (MAC) layer of the communication protocol stack; and
the DU at least partially controls operation of the RU;
a cloud server communicatively coupled to each of the plurality of small cell radio access points, wherein:
the cloud server implements a Control Unit (CU) that at least supports a service data adaptation protocol (SDAP) layer, a packet data convergence protocol (PDCP) layer and a radio resource control (RRC) layer of the communication protocol stack; and
the CU at least partially controls operation of a plurality of DUs associated with the plurality of small cell radio access points; and
a network core communicatively coupled to the cloud server, wherein the CU provides each small cell radio access point access to the network core.

2. The cellular communication system of claim 1, wherein the CU is configured to:
receive, from a UE communicatively coupled to a first small cell radio access point, a first indication of a first signal quality associated with the first small cell radio access point;
receive, from the UE, an indication of a second signal quality associated with a second small cell radio access point;
determine to handover the UE from the first small cell radio access point to the second small cell radio access point based at least in part upon the first signal quality and the second signal quality; and
handover the UE from the first small cell radio access point to the second small cell radio access point.

3. The cellular communication system of claim 1, wherein the CU is configured to coordinate between two or more of the small cell radio access points with overlapping cell coverages to implement Inter-Cell Interference Coordination (ICIC) to reduce signal interference between the two or more small cell radio access points.

4. The cellular communication system of claim 1, further comprising:
a macro base station communicatively coupled to the CU, wherein the CU at least partially controls operation of the macro base station.

5. The cellular communication system of claim 4, wherein the CU is configured to provide dual connectivity of a UE with a first small cell radio access point and the macro base station by:
assigning a first carrier frequency for communication between the UE and the first small cell radio access point; and
assigning a second carrier frequency for communication between the UE and the macro base station.

6. The cellular communication system of claim 4, wherein the CU is configured to control handover of a UE between a first small cell radio access point and the macro base station.

7. The cellular communication system of claim 1, wherein the CU is configured to provide dual connectivity of a UE with a first small cell radio access point and a second small cell radio access point by:
assigning a first carrier frequency for communication between the UE and the first small cell radio access point; and
assigning a second carrier frequency for communication between the UE and the second small cell radio access point.

8. A method for wireless communication, the method comprising:
deploying a plurality of small cell radio access points, wherein:
each small cell radio access point is associated with a small cell comprising a femto cell, a pico cell or a micro cell;
each small cell radio access point comprises a Radio Unit (RU) and a Distributed Unit (DU) communicatively coupled to the RU;
the RU comprises radio hardware used to communicate with user equipment (UEs) and supports at least a physical (PHY) layer of a communication protocol stack associated with a cellular network;
the DU is a software entity deployed by a computing node at the radio access point and supports at least a radio link control (RLC) layer and a medium access control (MAC) layer of the communication protocol stack; and
the DU at least partially controls operation of the RU; and
deploying a cloud server communicatively coupled to each of the plurality of small cell radio access points, wherein:
the cloud server implements a Control Unit (CU) that at least supports a service data adaptation protocol (SDAP) layer, a packet data convergence protocol (PDCP) layer and a radio resource control (RRC) layer of the communication protocol stack; and
the CU at least partially controls operation of a plurality of DUs associated with the plurality of small cell radio access points; and
wherein a network core is communicatively coupled to the cloud server, wherein the CU provides each small cell radio access point access to the network core.

9. The method of claim 8, wherein the CU handovers a UE from a first radio access point to a second small cell radio access point by:
receiving, from a UE communicatively coupled to a first small cell radio access point, a first indication of a first signal quality associated with the first small cell radio access point;
receiving, from the UE, an indication of a second signal quality associated with a second small cell radio access point;
determining to handover the UE from the first small cell radio access point to the second small cell radio access point based on the first signal quality and the second signal quality; and
handing over the UE from the first small cell radio access point to the second small cell radio access point.

10. The method of claim 8, wherein the CU coordinates between two or more of the small cell radio access points with overlapping cell coverage to implement Inter-Cell Interference Coordination (ICIC) to reduce signal interference between the two or more small cell radio access points.

11. The method of claim 8, further comprising:
deploying a macro base station communicatively coupled to the CU, wherein the CU at least partially controls operation of the macro base station.

12. The method of claim 11, wherein the CU provides dual connectivity of a UE with a first small cell radio access point and the macro base station by:
assigning a first carrier frequency for communication between a UE and the first small cell radio access point; and
assigning a second carrier frequency for communication between the UE and the macro base station.

13. The method of claim 11, wherein the CU controls handover of a UE between a first small cell radio access point and the macro base station.

14. The method of claim 8, wherein the CU provides dual connectivity of a UE with a first small cell radio access point and a second small cell radio access point by:
assigning a first carrier frequency for communication between the UE and the first small cell radio access point; and
assigning a second carrier frequency for communication between the UE and the second small cell radio access point.

15. A control unit comprising:
a memory storing software instructions; and
a processor communicatively coupled to the memory and configured to execute the software instructions to:
implement a service data adaptation protocol (SDAP) layer, a packet data convergence protocol (PDCP) layer and a radio resource control (RRC) layer of a communication protocol stack associated with a cellular network;
at least partially control operation of a plurality of small cell radio access points; and
provide each small cell radio access point access to a network core;
wherein:
each small cell radio access point is associated with a small cell comprising a femto cell, a pico cell or a micro cell;
each small cell radio access point comprises a Radio Unit (RU) and a Distributed Unit (DU) communicatively coupled to the RU;
the RU comprises radio hardware used to communicate with user equipment (UEs) and supports at least a physical (PHY) layer of a communication protocol stack associated with the cellular network;
the DU is a software entity deployed by a computing node at the radio access point and supports at least a radio link control (RLC) layer and a medium access control (MAC) layer of the communication protocol stack; and
the DU at least partially controls operation of the RU.

16. The control unit of claim 15, wherein the processor is further configured to:
receive, from a UE communicatively coupled to a first small cell radio access point, a first indication of a first signal quality associated with the first small cell radio access point;
receive, from the UE, an indication of a second signal quality associated with a second small cell radio access point;
determine to handover the UE from the first small cell radio access point to the second small cell radio access point based at least in part upon the first signal quality and the second signal quality; and
handover the UE from the first small cell radio access point to the second small cell radio access point.

17. The control unit of claim 15, wherein the processor is further configured to coordinate between two or more of the small cell radio access points with overlapping cell coverages to implement Inter-Cell Interference Coordination (ICIC) to reduce signal interference between the two or more small cell radio access points.

18. The control unit of claim 15, wherein the processor is further configured to:
at least partially control operation of a macro base station communicatively coupled to the control unit.

19. The control unit of claim 18, wherein the processor is further configured to provide dual connectivity of a UE with a first small cell radio access point and the macro base station by:
assigning a first carrier frequency for communication between the UE and the first small cell radio access point; and
assigning a second carrier frequency for communication between the UE and the macro base station.

20. The control unit of claim 18, wherein the processor is further configured to control handover of a UE between a first small cell radio access point and the macro base station.
